(19) United States
(12) Patent Application Publication
(10) Pub. No.: US 2010/0309188 A1
(43) Pub. Date: Dec. 9, 2010

(54) Driver for a projection system

(75) Inventors: Ralf Hying, Muenchen (DE); Andreas Huber, Maisach (DE); Peter Niedermeier, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/864,678

(22) PCT Filed: Jan. 28, 2008
(86) PCT No.: PCT/EP08/50962

§ 371 Date: Jul. 27, 2010

(51) Int. Cl. G09G 5/00; G03B 21/14

(52) U.S. Cl. 345/211; 353/30

(57) ABSTRACT

A driver for a plurality of semiconductor light sources is provided. The driver may include a plurality of means configured to provide current for in each case at least one semiconductor light source, wherein the driver includes a unit, composed of a power factor corrector and at least one DC/DC converter or is coupled to such a unit, an output of the DC-DC converter being directly connected to the means configured to provide current.

### TECHNICAL FIELD

The invention relates to a driver for a plurality of semiconductor light sources according to the preamble of patent claim 1.

### PRIOR ART

Semiconductor light sources, primarily light-emitting diodes (LEDs), are being used increasingly often in projection systems. A driver is provided for these LEDs. The driver includes suitable means for providing current, to be precise usually a plurality of such means, namely one for each LED color. Often a single LED is respectively provided per color (red, green, blue), but a plurality of LEDs in a semiconductor light source branch can also be fed by the means for providing current. The means for providing current are usually embodied as linear controllers, because the latter have fast switching times.

The linear controller is supplied with a voltage that is slightly higher than the maximum forward voltage of that one of the three diodes (or of the diode arrangements in the individual branches) which has the highest maximum forward voltage. By way of example, if the reverse voltage of a red light diode is 4 V, that of a green light diode is 6.2 V and that of a blue light diode is 6.5 V, then the linear controllers should be supplied with a voltage of 7 V or lower, in any event somewhat higher than 6.5 V, e.g. starting from 6.55 V up to 7.0 V.

What is disadvantageous in this case is, firstly, that an excessively high voltage is applied to the linear controller for the red light diode and a somewhat excessively high voltage is also applied to the linear controller for the green light diode. An excessive amount of energy is converted into heat in this case. Moreover, the voltage of approximately 7 V or less is provided in the driver by a so-called preliminary controller, which is usually designed as a DC-DC converter. The preliminary controller is usually not directly connected to the power supply system. There are usually separate power supply units in the system, e.g. in the projector, which are connected to the power supply system and into which a power factor corrector (PFC) is integrated, and also a DC-DC converter that applies a voltage of e.g. 16 V to the preliminary controller. The reason for using such a power supply unit is that a power factor corrector is prescribed: an ohmic resistance is intended to be simulated for the power supply system. The previous arrangement appears to be very complicated overall.

### SUMMARY OF THE INVENTION

The object of the present invention is to provide a driver for a plurality of LEDs in accordance with the preamble of patent claim 1, which driver can be connected as far as possible directly to the power supply system and thus enables an uncomplicated arrangement.

In the case of a driver including the features of the preamble of patent claim 1, this object is achieved by means of the feature of the characterizing part of patent claim 1. Particularly advantageous configurations are found in the dependent patent claims.

According to the invention, therefore, the driver includes a unit composed of power factor corrector (PFC) and at least one DC-DC converter, at least one output of the DC-DC converter being directly connected to the means for providing current.

By virtue of the invention, firstly the power factor corrector is integrated into the driver such that the driver can be connected directly to the power supply system. Moreover the voltage is no longer converted from the power supply system voltage to 16 V via a first DC-DC converter and from 16 V to 7 V or less by a second DC-DC converter, rather an output voltage is provided directly by a single DC-DC converter, which supplies the linear controllers with voltage.

The unit need not necessarily be integrated into the driver, but rather can, in the projection system in which the driver is used, be coupled to the latter. The previous preliminary controller is in any event obviated however.

The DC-DC converter is preferably a forward converter, because this is a particularly widely used and therefore cost-effective converter.

The arrangement enables an embodiment in which the unit integrated into the driver can provide different voltages simultaneously, to be precise at different outputs. If each output is then connected to a respective means for providing current, the exactly appropriate voltage can be provided for each diode or each diode branch, such than an excessive amount of heat is not generated.

One unit which has the properties mentioned is e.g. a commercially available ATX power supply unit, that is to say a known computer power supply unit. The latter is available in a cost-effective manner and can be integrated into a driver in a very simple manner.

Preferably, the output voltages at the outputs of the unit can be set, to be precise in a manner controllable by control signals. For this purpose, the unit should have a control input. This feature enables, in particular, the optimum setting of the output voltages in the case of power supply units integrated into the driver which were not constructed a priori for such a driver. By way of example, the abovementioned ATX power supply unit usually includes such a control input (also designated as “sense” input).

In a manner known per se, the driver has a digital control unit, which drives the means for providing current in a customary manner. In the case where the unit has a control input, the digital control unit can indeed also be coupled to said control input in order to be able to feed the control signals to the unit.

A circuit arrangement in which the driver can be used can dispense with any intermediate element between the driver and the power supply system. The use of a driver and of such an arrangement is claimed in patent claim 7.

The driver according to the invention is preferably provided for the supply of LEDs in a projection system, which is also claimed in patent claim 8.

### BRIEF DESCRIPTION OF THE DRAWINGS

The invention will be explained in greater detail below on the basis of an exemplary embodiment. In the figures:

FIG. 1 schematically shows the construction of a driver in accordance with the prior art; and

FIG. 2 schematically shows the construction of a driver according to the invention.

### PREFERRED EMBODIMENT OF THE INVENTION

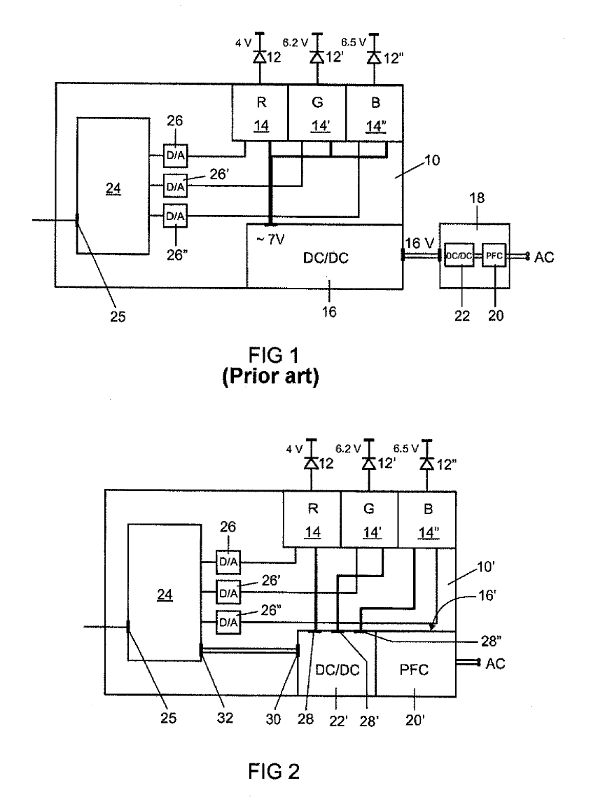

A driver from the prior art as shown in FIG. 1, said driver being designated by 10, is usually coupled to a plurality of LEDs 12, 12′, 12″ in a projection system, to be precise to an LED 12 that emits red light, an LED 12′ that emits green light and LED 12″ that emits blue light. The task of the driver 10 is to apply current to the LEDs 12, 12′, 12″. For this purpose, a linear controller 14, 14′, 14″ is provided for each LED color in the driver. A voltage is fed to the linear controllers 14, 14′, 14″; to be precise, said voltage should be between 3 and 10% higher than the highest maximum forward voltage of the diodes 12, 12′, 12″. The reverse voltage of the diode 12″ that emits blue light is the highest, and specifically has a value of 6.5 V, while that of the other diodes is 4 V (diode 12) and 6.2 V (diode 12′). A voltage of around approximately 7 V or less down to 6.5 V should therefore be applied to the linear controllers 14, 14′, 14″. In order to provide this voltage, the driver 10 includes a preliminary controller 16, which is preferably embodied as a DC-DC converter and receives an input voltage of e.g. 16V. In the prior art, the preliminary controller is not directly connected to the power supply system (“AC”), rather a power supply unit is connected upstream, in which a power factor corrector (PFC) 20 and a DC-DC converter 22 are arranged. The power supply unit provides the input voltage 16 V for the preliminary controller 16.

The driver 10 furthermore includes a digital control unit 24 (which is embodied as a microcontroller, for example), which receives control signals via an input 25 and converts them into suitable control signals for the linear controllers 14, 14′, 14″; to be precise, it transits said control signals via a digital-to-analog converter 26 and 26′, 26″, respectively, to the linear controllers 14, 14′, 14″.

A driver 10″ according to the invention differs from the driver 10 in that it can be connected directly to the power supply system (“AC”). For this purpose, instead of the preliminary controller 16 from the driver 10, a unit 16′ is integrated into the driver, said unit comprising a power factor corrector 20′ in the manner of the power factor corrector 20 from the power supply unit 18 and also a DC-DC converter 22′. The unit 16′ can be a power supply unit that is commercially available in a conventional manner, such power supply units being available inexpensively in particular as computer power supply units (e.g. so-called ATX power supply units).

The unit 16′ now no longer has only one output, but rather has a plurality of outputs 28, 28′, 28″, these outputs in each case being connected to a linear controller 14, 14′ and 14″, respectively. Each linear controller can thus be fed such a voltage which is between 3 and 10% above the maximum forward voltage of the respective diode driven by the linear controller. Thus, at the output 28 a voltage of 4.1 V can be output, which is just above the voltage 4 V of the diode 12, at the output 28′ a voltage of 6.3 V can be applied, which is just above the reverse voltage of 6.2 V of the diode 12′ and at the output 28″ a voltage of 6.6 V (or else the previous 7 V) can be output, which is just above the reverse voltage of 6.5 V of the diode 12″. ATX power supply units, in particular, have a plurality of such outputs. Not all ATX power supply units are designed a priori for outputting exactly the required voltages. The voltages are controllable, however, to be precise via an input 30. In the case of the driver 10′, the control input 30 of the unit 16′ is now connected to a control output 32 of the control unit 24, such that the control unit 24 can define the voltages at the outputs 28, 28′, 28″.

The driver 10′ is constructed significantly more compactly than the arrangement composed of driver 10 and power supply unit 18 in the prior art. The driver 10′ can be connected directly to the power supply system. Less heat loss arises, because a dedicated voltage is respectively applied to the individual linear controllers 14, 14′, 14″.

1. A driver for a plurality of semiconductor light sources, the driver comprising:
a plurality of means configured to provide current for in each case at least one semiconductor light source,
wherein
the driver comprises a unit, composed of a power factor corrector and at least one DC/DC converter or is coupled to such a unit, an output of the DC-DC converter being directly connected to the means configured to provide current.

2. The driver as claimed in claim 1,
wherein
the DC-DC converter is a forward converter.

3. The driver as claimed in claim 1,
wherein
the unit has a plurality of outputs, of which each output is respectively connected to a means configured to provide current.

4. The driver as claimed in claim 1,
wherein
the unit comprises an ATX power supply unit.

5. The driver as claimed in claim 1,
wherein
the unit has a control input, the voltage present at each output being able to be defined by signals fed via the control input.

6. The driver as claimed in claim 5, further comprising:
a digital control unit, which is coupled to the control input.

7. A use of a driver in an arrangement in which the driver is directly connected to a power supply system, the driver comprising:
a plurality of means configured to provide current for in each case at least one semiconductor light source,
wherein the driver comprises a unit, composed of a power factor corrector and at least one DC/DC converter or is coupled to such a unit, an output of the DC-DC converter being directly connected to the means configured to provide current.

8. A projection system, comprising:
a plurality of light emitting diodes and a driver, which serves to supply the light emitting diodes with current, the driver comprising:
a plurality of means configured to provide current for in each case at least one semiconductor light source,
wherein the driver comprises a unit, composed of a power factor corrector and at least one DC/DC converter or is coupled to such a unit, an output of the DC-DC converter being directly connected to the means configured to provide current.
